(19) United States
(12) Patent Application Publication
(10) Pub. No.: US 2016/0266376 A1
(43) Pub. Date: Sep. 15, 2016

(54) ACTIVE REFLECTIVE LENS AND APPARATUS USING THE SAME

(71) Applicant: ELECTRONICS AND TELECOMMUNICATIONS RESEARCH INSTITUTE, Daejeon (KR)

(72) Inventors: Sae Kwang NAM, Daejeon (KR); Sun Tak PARK, Incheon (KR); Ki Uk KYUNG, Daejeon (KR); Bong Je PARK, Daejeon (KR); Sung Ryul YUN, Daejeon (KR)

(73) Assignee: ELECTRONICS AND TELECOMMUNICATIONS RESEARCH INSTIT UTE, Daejeon (KR)

(21) Appl. No.: 15/065,856

(22) Filed: Mar. 9, 2016

(30) Foreign Application Priority Data
Mar. 10, 2015 (KR) 10-2015-0033293
Feb. 29, 2016 (KR) 10-2016-0024647

(51) Int. Cl. G02B 26/08; G02B 13/00

(52) U.S. Cl. CPC G02B 26/0825; G02B 13/0065; G02B 13/0075; G02B 13/009

(57) ABSTRACT

Provided herein are a reflective lens capable of changing a focal length and an optical system using the same. An active reflective lens according to an embodiment includes: a lens unit including material that is deformable in response to an electric signal; a support unit configured to support the lens unit; a base unit formed below the support unit; a first electrode formed on the lens unit; and a second electrode formed on the base unit. The distance between the first electrode and the second electrode is determined depending on a shape of an upper surface of the base unit, and the distance between the first electrode and the second electrode varies depending on regions of the lens unit.

### CROSS-REFERENCE TO RELATED APPLICATION

The present application claims priority to Korean Patent Application Numbers 10-2015-0033293 filed on Mar. 10, 2015 and 10-2016-0024647 filed on Feb. 29, 2016, in the Korean Intellectual Property Office, the entire disclosure of which is incorporated by reference herein.

### BACKGROUND

1. Field of Invention

Various embodiments of the present disclosure relate to a reflective lens capable of changing a focal length, and an optical system using the same. More particularly, various embodiments of the present disclosure relate to a method of embodying a lens without aberration, a reflective lens to which the method is applied, and an apparatus using the same.

2. Description of Related Art

Recently, as digital technology pertaining to cameras, portable terminals, TVs, projectors, medical devices, etc. has progressed, a reduction in thickness, weight and size of a high-resolution display is required. Furthermore, a reduction in size of an optical lens system for a high-definition image is required, and research on this has become appreciably more active. In particular, as a camera module for portable terminals is mounted with a high-definition image sensor, the importance of functions, such as a varifocal function and an optical zoom function, and a reduction in size is being further emphasized. A conventional camera module employs actuators to vary the positions of lenses and thus implement the varifocal and optical zoom functions.

With regard to an automatic zoom function according to a conventional technique, the focal length is automatically adjusted in such a way that a plurality of actuators adjust positions of a plurality of lens. Each actuator may be a voice coil motor (VCM), a piezoelectric actuator, or a step motor. The VCM uses current flowing through a coil and electromagnetic force generated by a magnet so as to move a lens. However, electromagnetic waves are generated, and the precision is limited. The piezoelectric actuator uses friction between a stator and a rotor to move the lens. However, there are disadvantages in that the lifetime is reduced by abrasion, and the production cost is comparatively high. The step motor rotates a lead screw to linearly move a lens. However, there are disadvantages in that operating mechanism is complex, and noise is caused by friction in a gear unit.

A conventional reflective varifocal lens adjusts a focal length thereof using a method of injecting gas or fluid into chamber and accordingly changing the pressure in the chamber. However, because there is the need for an additional pressure regulator or the like, it is difficult to reduce the size a device or array elements. Furthermore, there is a disadvantage in that the manufacturing process and the structure of the lens are complex and the production cost is thus increased.

That is, in the case of the conventional techniques, a reduction in thickness and weight of the optical apparatus is limited because the structure thereof is complex, and the production cost is comparatively high.

### SUMMARY

Various embodiments of the present disclosure are directed to an active reflective lens having a structure which is simple and is capable of reducing the size thereof. Furthermore, various embodiments of the present disclosure are directed to an active reflective lens which facilitates focal length adjustment and aberration compensation.

The objects of the present disclosure are not limited to the above-mentioned object, and those skilled in this art will be able to easily understand other unmentioned objects from the following description.

One embodiment of the present disclosure provides an active reflective lens including: a lens unit including material that is deformable in response to an electric signal; a support unit configured to support the lens unit; a base unit formed below the support unit; a first electrode formed on the lens unit; and a second electrode formed on the base unit, wherein a distance between the first electrode and the second electrode is determined depending on a shape of an upper surface of the base unit, and the distance between the first electrode and the second electrode varies depending on regions of the lens unit.

Another embodiment of the present disclosure provides an optical apparatus including an active reflective lens, the active reflective lens including: a lens unit including material that is deformable in response to an electric signal; a support unit configured to support the lens unit; a base unit formed below the support unit; a first electrode formed on the lens unit; and a second electrode formed on the base unit, wherein a distance between the first electrode and the second electrode is determined depending on a shape of an upper surface of the base unit, and the distance between the first electrode and the second electrode varies depending on regions of the lens unit.

In various embodiments of the present disclosure, a lens unit is formed of a functional polymer that is changeable in shape depending on the intensity or pattern of an electric field. Therefore, the focal length of the lens unit can be adjusted by changing the shape of the lens unit depending on electrostatic force between electrodes provided around the lens unit. Furthermore, the curvature of the lens unit may be precisely compensated for using the initial shape of a base unit or a change in shape of the base unit. Therefore, the present disclosure may provide an active reflective lens which can be electrically driven without using external physical force or internal pressure, and an optical apparatus including the same.

Various embodiments of the present disclosure may provide an active reflective lens which has a simple structure and is able to have a reduced size and provide an arrayed structure, and an optical apparatus including the same. In addition, various embodiments of the present disclosure may provide an active reflective lens which has an increased focus change range and is able to rapidly change the focus of the lens, and an optical apparatus including the same.

The effects of the present disclosure are not limited to the above-mentioned effects, and those skilled in this art will be able to easily understand other unmentioned effects from the following description.

### BRIEF DESCRIPTION OF THE DRAWINGS

FIG. 1 is an example of a configuration diagram of an active reflective lens according to an embodiment of the present disclosure;

FIG. 2 is a sectional view showing the configuration of the active reflective lens according to the embodiment of the present disclosure;

FIGS. 3A to 3C are sectional views illustrating a method of designing and operating an active reflective lens according to an embodiment of the present disclosure;

FIGS. 4A and 4B are sectional views illustrating a method of designing and operating an active reflective lens according to another embodiment of the present disclosure;

FIGS. 5A and 5B are sectional views illustrating a method of designing and operating an active reflective lens according to another embodiment of the present disclosure;

FIGS. 6A and 6B are sectional views illustrating a method of designing and operating an active reflective lens according to another embodiment of the present disclosure;

FIGS. 7A and 7B are sectional views illustrating a method of designing and operating an active reflective lens according to another embodiment of the present disclosure;

FIG. 8 is a view illustrating an example of an optical system including an active reflective lens according to an embodiment of the present disclosure; and

FIG. 9 is a view illustrating another example of an optical system including an active reflective lens according to an embodiment of the present disclosure.

### DETAILED DESCRIPTION

Hereinafter, exemplary embodiments of the present disclosure will be described in detail with reference to the attached drawings.

Detailed description of functions and structures well known to those skilled in the art will be omitted to avoid obscuring the subject matter of the present disclosure. This aims to omit unnecessary description so as to make the subject matter of the present disclosure clear.

It will be understood that when an element is referred to as being “coupled” or “connected” to another embodiment, it can be directly coupled or connected to the other element or intervening elements may be present therebetween so that the elements may be electrically coupled to each other. In the specification, when it is said that a specific element is “included”, it may mean that elements other than the specific element are not excluded and that additional elements may be included in the embodiments of the present invention or the scope of the technical spirit of the present invention.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

Furthermore, components shown in the embodiments of the present invention are independently shown so as to represent different characteristic functions. Thus, it does not mean that each component forms a constituent unit of separate hardware or one software. That is, the elements are independently arranged for convenience of description, wherein at least two elements may be combined into a single element, or a single element may be divided into a plurality of elements to perform functions. It is to be noted that embodiments in which some elements are integrated into one combined element and/or an element is divided into multiple separate elements are included in the scope of the present invention without departing from the essence of the present disclosure.

Furthermore, some elements may not be essential to the substantial functions in the present disclosure, and may be optional elements for merely improving performance. The present disclosure may be embodied by including only elements essential to embodiment of the present disclosure, except for elements used to merely improve performance. The structure including only the essential elements except for the optical elements used to merely improve performance belongs to the scope of the present disclosure.

If, in the specification, detailed descriptions of well-known functions or configurations would unnecessarily obfuscate the gist of the present disclosure, the detailed descriptions will be omitted. Hereinafter, exemplary embodiments of the present disclosure will be described in detail with reference to the attached drawings. The terms and words used for elements in the description of the present invention are determined based on the functions of the elements in the present invention. The terms and words may be changed depending on the intention or custom of users or operators, so that they must be defined based on the whole content of the present specification.

An active reflective lens according to an embodiment of the present disclosure may include a thin flexible film layer formed of a shape-variable material, for example, an electroactive polymer. The film layer may function as a lens and have a reflective region coated with a metal layer. In the case where the coated metal layer is used as an electrode, an electric field may be formed by applying a voltage to the metal layer and an electrode formed on an upper surface of a base unit. Therefore, the film layer may be curved at a predetermined curvature by the electric field. When the film layer makes a curvature, the film layer is deformed in a direction in which an electromagnetic field is formed. Therefore, it is essential to secure space required for the deformation of the film layer. The perimeter of the coated film layer may be fixed by a support. In the case of the active reflective lens according to an embodiment of the present disclosure, when the film layer forms a curved surface due to an electromagnetic field, a base unit with an electrode changes in shape so that the curved surface of the film layer can be compensated for, whereby the aberration problem can be solved. The active reflective lens according to an embodiment of the present disclosure may include a lens unit in which a reflective film is applied on a flexible film functioning as a lens, a support unit which fixes the perimeter of a lens of the lens unit and secures space to allow the lens unit to be deformed, a base unit which includes at least one electrode layer and has a key role in determining the shape of a curved surface of the lens, and a power supply which includes a controller that controls the power supply to provide an electrical signal to the electrode.

Hereinafter, embodiments of the present disclosure will be described in more detail.

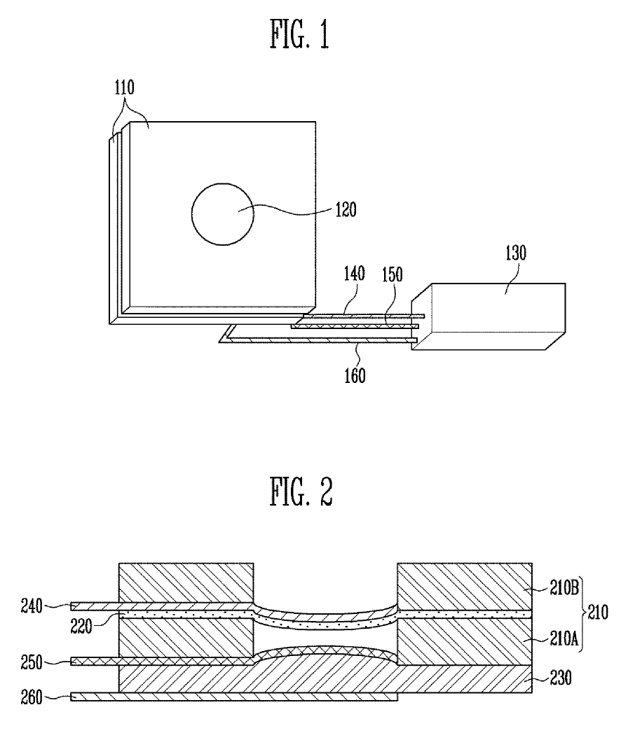

FIG. 1 is an example of a configuration diagram of an active reflective lens according to an embodiment of the present disclosure.

Referring to FIG. 1, the active reflective lens according to the embodiment of the present disclosure may include a lens structure body, and a power supply 130. The lens structure body may include a support unit 110 and a lens unit 120. Although not shown, the lens structure body may further include a base unit. The power supply 130 may apply voltage to the lens structure body through at least one electrode 140, 150, 160. The power supply 130 may include a controller that controls to provide an electrical signal to the lens structure body.

When a voltage is applied from the power supply 130, an electric field may be accordingly formed on the lens structure body. Depending on the formed electric field, the lens unit 120 having a film shape may form a convex or concave shape based on the support unit 110 that is fixed over and below a film layer.

FIG. 2 is a sectional view showing the configuration of the active reflective lens according to the embodiment of the present disclosure.

Referring to FIG. 2, the lens structure body according to the present embodiment may include a support unit 210, a lens unit 220, a base unit 230, a first electrode 240 and a second electrode 250. The lens structure body may further include a third electrode 260 provided to compensate for aberration.

The lens unit 220 includes material that is deformable depending on an electric signal. Depending on a deformed shape, the focal length of the lens unit 220 is changed. For example, the lens unit 220 may include dielectric material and have the form of a thin flexible film. The lens unit 220 may be supported by the support unit 210. In an embodiment, the lens unit 220 may be interposed in a sandwich shape between a lower support unit 210A and an upper support unit 210B. The lens unit 220 includes a drive region that is deformable, and a non-drive region that is not deformable. Therefore, the support unit 210 fixes the non-drive region of the lens unit 220 in place and has an opening at a position corresponding to the drive region of the lens unit 220. Thereby, a reflective region of the lens unit 220 is exposed to the outside, and the shape of the drive region of the lens unit 220 can be changed in response to an electric signal. The first electrode 240 may be formed in the reflective region of the lens unit 220. In other words, the first electrode 240 may be formed in the drive region of the lens unit 220 that is exposed to the outside through the opening of the support unit 210. For instance, the first electrode 240 may be a metal film applied on a portion of an upper surface of the lens unit 220 or a lower surface of the lens unit 220. Furthermore, the first electrode 240 may be electrically coupled to the power supply 130 so that a voltage can be applied from the power supply 130 to the first electrode 240.

The base unit 230 is disposed below the lens unit 220 and the support 210 and may include material that is deformable in response to an electric signal. The second electrode 250 is formed on the base unit 230. In this regard, the second electrode 250 may be formed at a position corresponding to the first electrode 240 and extended to be electrically coupled to the power supply 130. Thereby, a voltage may be applied from the power supply 130 to the second electrode 250. In addition, the third electrode 260 may be formed under the base unit 230. The third electrode 260 may be formed at a position corresponding to the second electrode 250 and extended to be electrically coupled to the power supply 130. For reference, the first to third electrodes 240 to 260 may be insulated from each other. The power supply 130 may apply a voltage to each of the first to third electrodes 240 to 260.

Furthermore, the distance between the first electrode 240 and the second electrode 250 is determined depending on the shape of an upper surface of the base unit 230. In the case where the upper surface of the base unit 230 has a concave shape, a convex shape or the like, the distance between the first electrode 240 and the second electrode 250 varies depending on regions of the lens unit 220. For example, in the case where the base unit 230 has a convex shape, the distance between the first electrode 240 and the second electrode 250 is relatively short on an axially central portion of the lens unit 220, while the distance between the first electrode 240 and the second electrode 250 is relatively long on an edge portion of the drive region of the lens unit 220. In another example, if the base unit 230 has a concave shape, the distance between the first electrode 240 and the second electrode 250 is relatively long on the axially central portion of the lens unit 220, while the distance between the first electrode 240 and the second electrode 250 is relatively short on the edge portion of the drive region of the lens unit 220.

Although, in FIG. 2, there is illustrated the case where the upper surface of the base unit 230 is convex toward the lens unit 220, the present disclosure is not limited to this. In some embodiments, the upper surface of the base unit 230 may be flat or concave. Furthermore, the entire region of the upper surface of the base unit 230 may have a convex, concave or flat shape. Alternatively, only a portion of the base unit 230 that corresponds to the drive region of the lens unit 220 may have a convex, concave or flat shape. In addition, the base unit 230 may be formed with only either the second electrode 250 or the third electrode 260, or with both.

According to the above-described configuration, the shape of the lens unit 220 may be changed in response to an electric signal so that the focal length thereof can be adjusted, whereby the aberration can be compensated for. Particularly, depending on the material of the lens unit 220 or the shape of the base unit 230, the flat shape of the lens unit 220 may be changed into a convex or concave shape.

The lens unit 220 may include a polymer, for example, an elastomer having excellent restoring force. Therefore, when a voltage is applied to the first electrode 340 and the second electrode 350 by the power supply 130, electrostatic force is generated between the first electrode 340 and the second electrode 350, whereby the shape of the lens unit 220 that is interposed between the first electrode 340 and the second electrode 350 is deformed. Here, depending on the dielectric constant or properties of the material of the lens unit 220, the shape into which the lens unit 220 is deformed may be changed.

Furthermore, the base unit 230 may include a functional polymer, for example, an electro-active polymer having dielectric property. The electro-active polymer is deformable by an electric signal, and is material which is changeable in shape corresponding to electrostatic force formed between dielectric polymers. In this case, the second electrode 250 is formed on the upper surface of the base unit 230, and the third electrode 260 is formed on a lower surface of the base unit 230. Therefore, when a voltage is applied to the second electrode 250 and the third electrode 260 by the power supply 130, electrostatic force is generated between the second electrode 250 and the third electrode 260, whereby the shape of the base unit 230 that is interposed between the second electrode 250 and the third electrode 260 is changed.

In this regard, the first to third electrodes 240 to 260 may be formed of flexible material and include carbon rubber, carbon nano-composite, a silver nano-wire, etc. Therefore, the shapes of the first to third electrodes 240 to 260 can be changed corresponding to deformation of the lens unit 220 and the base unit 230. For example, when the upper surface of the base unit 230 is deformed, the curvature of the second electrode 250 is changed accordingly, and the curvature of first electrode 240 is changed according to the changed curvature of the second electrode 250. Consequently, after the lens unit 220 is primarily deformed by electrostatic force between the first electrode 240 and the second electrode 250, the base unit 230 is deformed by electrostatic force between the second electrode 250 and the third electrode 260. In this case, according to a change in the curvature of the second electrode 250, the curvature of the first electrode 240 is changed. Thus, the lens unit 220 may be secondarily deformed. Consequently, the curved surface of the lens unit 220 may be precisely controlled, whereby the aberration may be reliably compensated for. Furthermore, the first electrode 240 may be formed of a metal coating film having a smooth surface so as to function as a reflective surface. To prevent a crack from being caused due to a change in curvature, a thin metal coating film may be formed on the first electrode 240, or an additional surface treatment process may be performed after a metal coating film is formed thereon.

The electroactive polymer constituting the lens unit 220 and/or the base unit 230 may be material that causes physical deformation using migration and diffusion of ions of charges, an array of dipoles or electrostatic force when a voltage or charge is applied thereto. The electroactive polymer may be a kind of functional polymer that generates electric energy when physical deformation is applied thereto. For instance, the electroactive polymer may include an ionic EAP (electric active polymer) or an electronic EAP.

The ionic EAP may be a polymer that is contracted or expanded by migration and diffusion of ions when a voltage is applied thereto. Furthermore, the ionic EAP may include at least one of electrorheological fluid (ERF), a carbon nanotube (CNT), a conducting polymer (CP), an ionic polymer metal composite (IPMC), and ionic polymer gel (IPG).

The electronic EAP may be a polymer that is contracted or expanded by electronic polarization when electric energy is applied thereto. Furthermore, the electronic EAP may include at least one of a liquid crystal elastomer (LCE), an electro-viscoelastic elastomer, a dielectric elastomer (DE), a ferroelectric polymer, an electrostrictive graft elastomer, and electrostrictive paper.

In another example, the electronic EAP may include a dielectric substance that transfer electrical polarity but does not transfer electrons.

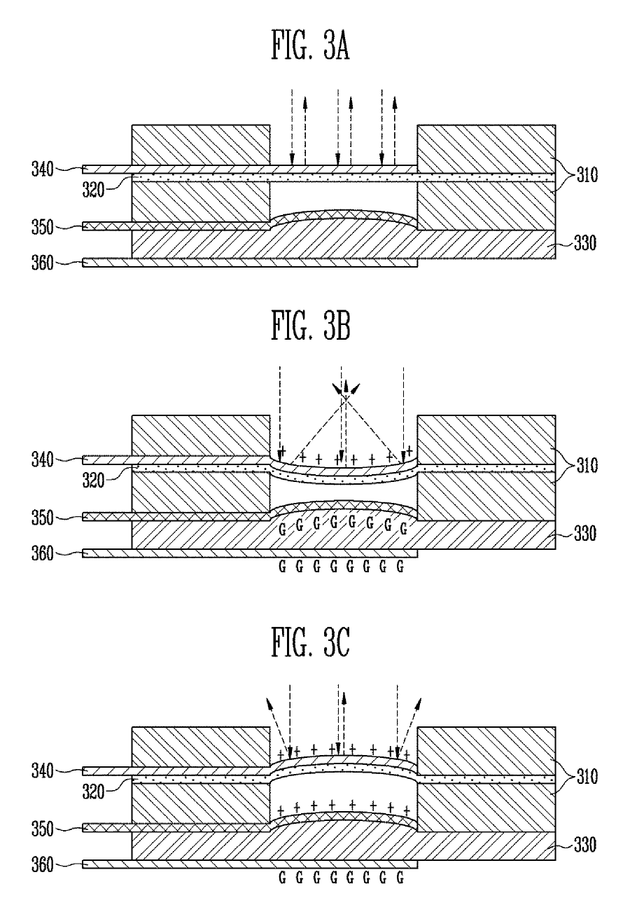

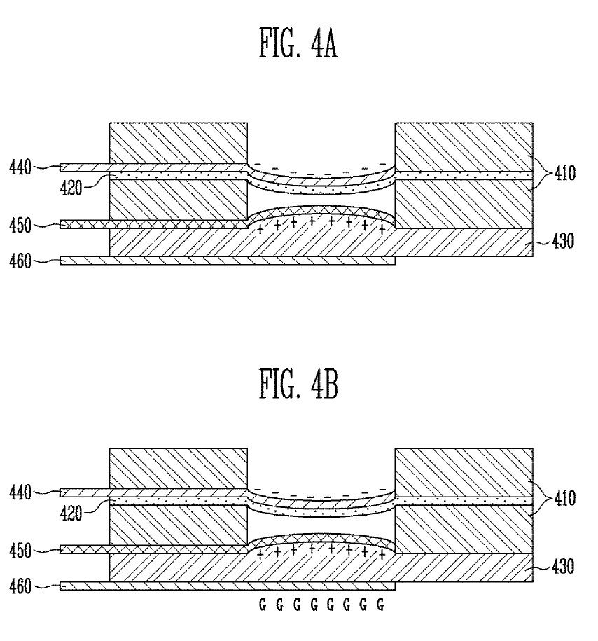

FIGS. 3A to 3C are sectional views illustrating a method of designing and operating an active reflective lens according to an embodiment of the present disclosure. Hereinafter, a method of designing a base unit 330 of an active reflective lens including a support unit 310, a lens unit 320, the base unit 330 and first to third electrodes 340 to 360 will be described. In the drawings, reference character “G” denotes the ground state or a state in which the electric potential is 0V.

The curved surface shape of the deformed lens unit 320 depends on a voltage applied to the first to third electrodes 340 to 360, the intensity of capacitance, or the intensity of electrostatic force. Therefore, if the distance between the first electrode 340 and the second electrode 350 is constant on the entire region of the lens unit 320, the lens unit 320 cannot be deformed into a perfect spherical shape. For example, the spherical surface of the deformed lens unit 320 may have a shape which is less convex than a spherical surface of a typical convex lens or less concave than a spherical surface of a typical concave lens. On the contrary, if the distance between the first electrode 340 and the second electrode 350 has a gradient, the spherical surface of the lens unit 320 may not changed into a shape falling within a focal length range desired by a user. In both two cases, lens aberration is caused.

Therefore, in an embodiment of the present invention, the base unit 330 has a convex or concave shape at the initial state. Thereby, the lens unit 320 can have a perfect spherical surface at the initial state. In addition, when an electric signal in a certain range is inputted, the lens unit 320 can be changed into a shape falling within the focal length range desired by the user. That is, to compensate for aberration or precisely control a variable focal length range, the base unit 330 is designed such that the distance between the first electrode 340 and the second electrode 350 varies depending on regions of the lens unit 320. In an example, if the spherical surface of the deformed lens unit 320 is less concave than desired, the based unit 330 is designed to have a convex shape toward the lens unit 320, whereby the spherical surface of the lens unit 320 may be deformed to have a more concave shape on the axially central portion thereof. In another example, if the spherical surface of the deformed lens unit 320 is less convex than desired, the axially central portion of the base unit 330 is increased in height, whereby the spherical surface of the lens unit 320 may be deformed to be more convex.

Referring to FIG. 3A, in the initial state in which no voltage is applied to the first to third electrodes 340 to 360, the lens unit 320 is maintained flat. Thus, the lens unit 320 forms an image in the same manner as that of a mirror.

Referring to FIG. 3B, the second and third electrodes 350 and 360 are grounded (G), and a positive (+) voltage or charge is applied to the first electrode 340 so that attractive force is generated between the first electrode 340 and the second electrode 350. In this case, because the distance between the first electrode 340 and the second electrode 350 varies depending on the shape of the base unit 330, the applied electrostatic force varies depending on regions of the lens unit 320. For example, since the distance between the first electrode 340 and the second electrode 350 is short on the central portion of the lens unit 320, the intensity of the attractive force is relatively large. On the other hand, since the distance between the first electrode 340 and the second electrode 350 is long on the edge of the lens unit 320, the intensity of the attractive force is relatively small. Therefore, the lens unit 320 is changed into a lens having a concave shape.

Referring to FIG. 3C, the third electrode 360 is grounded, and a positive (+) voltage or charge is applied to the first and second electrodes 340 and 350 so that repulsive force is generated between the first electrode 340 and the second electrode 350. In this case, because the distance between the first electrode 340 and the second electrode 350 varies depending on the shape of the base unit 330, the applied electrostatic force varies depending on regions of the lens unit 320. For example, since the distance between the first electrode 340 and the second electrode 350 is short on the central portion of the lens unit 320, the intensity of the repulsive force is relatively large. On the other hand, since the distance between the first electrode 340 and the second electrode 350 is long on the edge of the lens unit 320, the intensity of the repulsive force is relatively small. Therefore, the lens unit 320 is changed into a lens having a convex shape.

For reference, according to an embodiment of the present disclosure, as not only the shape of the base unit 330 but also the kind, intensity, etc. of a voltage applied to the first to third electrodes 340 to 360 are adjusted, the focal length of the active reflective lens may be controlled from minus to infinity or from infinity to minus.

FIGS. 4A and 4B are sectional views illustrating a method of designing and operating an active reflective lens according to another embodiment of the present disclosure. In the drawings, reference character “G” denotes the ground state, a state in which the electric potential is 0V, or an uncharged state.

While, in the embodiment described with reference to FIGS. 3A to 3C, there is illustrated the case where the shape of the base unit 330 is maintained in the initial shape, the case where the shape of a base unit 430 varies from the initial shape will be described in the present embodiment. The active reflective lens according to the present embodiment includes a support unit 410, a lens unit 420, the base unit 430, and first to third electrodes 440 to 460. The base unit 430 includes material that is deformable in response to an electric signal, for example, an electroactive polymer. Therefore, the shape of the base unit 430 changes depending on the kind and intensity of a voltage or charge applied to the second electrode 450 and the third electrode 460.

Referring to FIG. 4A, a negative (−) voltage or charge is applied to the first electrode 440, and a positive (+) voltage or charge is applied to the second electrode 450 so that attractive force is generated between the first electrode 440 and the second electrode 450. In this regard, the attractive force is affected by the initial shape of the base unit 430. For example, if the base unit 430 is excessively convex, the axially central portion of the curved surface of the lens unit 420 may excessively protrude downward, thus causing larger aberration.

Referring to FIG. 4B, the third electrode 460 is grounded or the electric potential thereof is set to 0 so that electrostatic force is generated between the second electrode 450 and the third electrode 460. In this case, the shape of the base unit 430 is changed by the electrostatic force, whereby the curvature of the second electrode 450 is changed. The curvature of the first electrode 440 changes depending on the changed curvature of the second electrode 450. The shape of the lens unit 420 thus changes. That is, the shape in which the axially central portion of the curved surface of the lens unit 420 excessively protrudes downward may be compensated for. Consequently, aberration can be partially or fully compensated for.

According to the above-described configuration, the shape of the base unit 430 may be changed in real time by adjusting the amount of electric charge which is charged in the second and third electrodes 450 and 460. For example, the shape of a region of the base unit 430 that corresponds to the drive region of the lens unit 420 may be changed by adjusting the intensity of electrostatic force applied to the base unit 430. Therefore, the convex portion of the base unit 430 may be made to be more convex, or the height of the convex portion of the base unit 430 may be reduced. Consequently, incorrect deformation of the lens unit 420 can be easily compensated for.

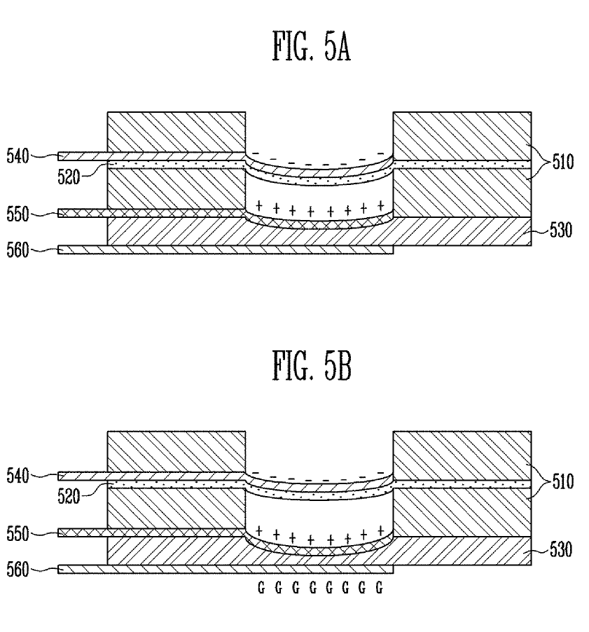

FIGS. 5A and 5B are sectional views illustrating a method of designing and operating an active reflective lens according to another embodiment of the present disclosure. In the drawings, reference character “G” denotes the ground state, a state in which the electric potential is OV, or an uncharged state.

While, in the embodiments described with reference to FIGS. 2 to 4B, there are illustrated the cases where the upper surfaces of the base units 230 to 430 have a convex shape, this is for the sake of explanation, and the present disclosure is not limited to this. The initial shape of a base unit 530 may change in various forms depending on conditions of variation in shape of a lens unit 520. In the present embodiment, there is illustrated the case where the active reflective lens includes a support unit 510, the lens unit 520, the base unit 530 and first to third electrodes 540 to 560, and the base unit 530 includes material that is deformable in response to an electric signal and has an initial concave shape.

Referring to FIG. 5A, a negative (−) voltage or charge is applied to the first electrode 540, and a positive (+) voltage or charge is applied to the second electrode 550 so that attractive force is generated between the first electrode 540 and the second electrode 550. In this regard, the attractive force is affected by the initial shape of the base unit 530. If the base unit 530 has a less concave shape, the distance between the first electrode 540 and the second electrode 550 is relatively short. In this case, the axially central portion of the curved surface of the lens unit 520 may excessively protrude downward, whereby aberration may be caused.

Referring to FIG. 5B, the third electrode 560 is grounded or the electric potential thereof is set to 0 so that electrostatic force is generated between the second electrode 550 and the third electrode 560. In this case, the shape of the base unit 530 is changed by electrostatic force, and the height of a region of the base unit 530 that corresponds to the axially central portion of the lens unit 520 is lowered. That is, the base unit 530 is compressed and thus has a more concave shape. Then, the distance between the first electrode 540 and the second electrode 550 is increased, so that the attractive force on the axially central portion of the lens unit 520 is reduced. That is, the shape in which the axially central portion of the curved surface of the lens unit 520 excessively protrudes downward may be compensated for. Consequently, aberration can be partially or fully compensated for.

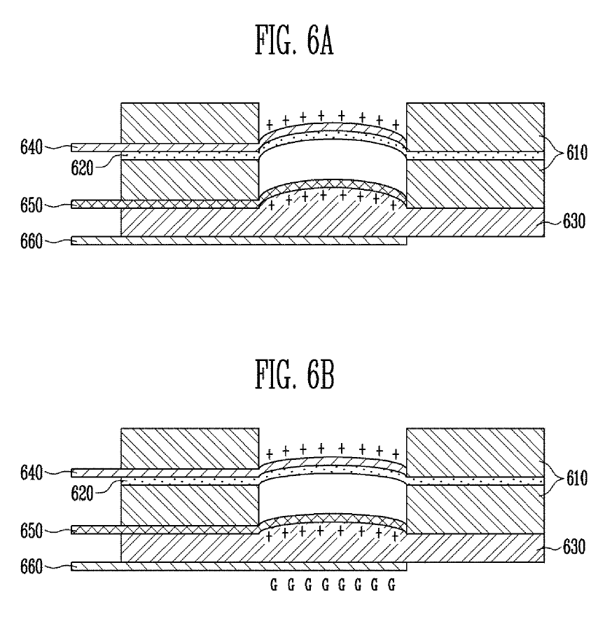

FIGS. 6A and 6B are sectional views illustrating a method of designing and operating an active reflective lens according to another embodiment of the present disclosure. In the drawings, reference character “G” denotes the ground state, a state in which the electric potential is 0V, or an uncharged state.

In the present embodiment, there is illustrated the case where the active reflective lens includes a support unit 610, a lens unit 620, a base unit 630 and first to third electrodes 640 to 660, and the base unit 630 includes material that is deformable in response to an electric signal and has an initial convex shape.

Referring to FIG. 6A, a positive (+) voltage or charge is applied to the first electrode 640, and a positive (+) voltage or charge is applied to the second electrode 650 so that repulsive force is generated between the first electrode 640 and the second electrode 650. In this regard, the repulsive force is affected by the initial shape of the base unit 630. If the base unit 630 is excessively convex, the axially central portion of the curved surface of the lens unit 620 may excessively protrude upward.

Referring to FIG. 6B, the third electrode 660 is grounded so that electrostatic force is generated between the second electrode 650 and the third electrode 660. The shape of the base unit 630 is changed by the electrostatic force. For example, a region of the base unit 630 that corresponds to the drive region of the lens unit 620 is compressed and thus lowered in height. That is, the base unit 630 has a less convex shape. Therefore, the shape in which the axially central portion of the curved surface of the lens unit 620 excessively protrudes upward may be compensated for. Consequently, generated aberration can be partially or fully compensated for.

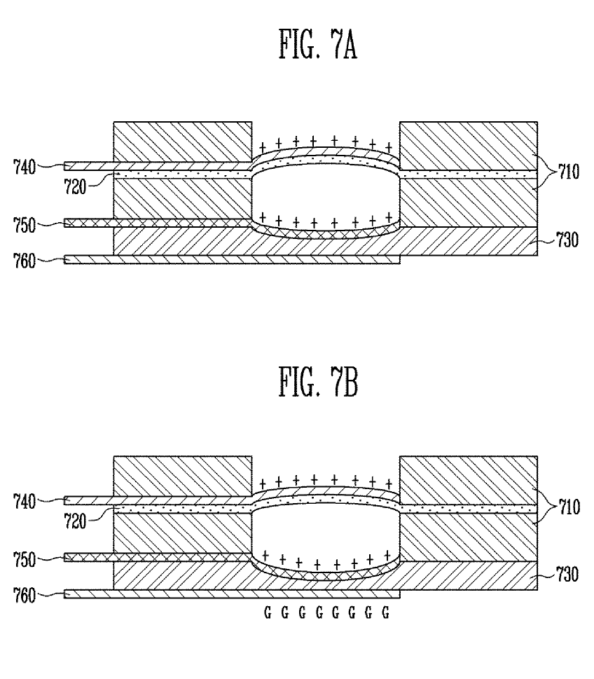

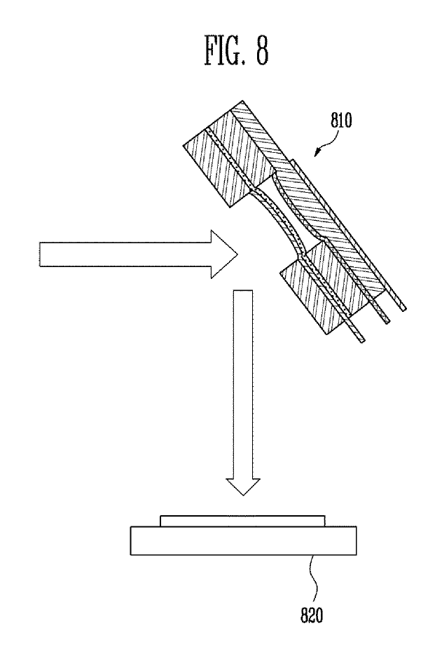

FIGS. 7A and 7B are sectional views illustrating a method of designing and operating an active reflective lens according to another embodiment of the present disclosure. In the drawings, reference character “G” denotes the ground state, a state in which the electric potential is 0V, or an uncharged state.

In the present embodiment, there is illustrated the case where the active reflective lens includes a support unit 710, a lens unit 720, a base unit 730 and first to third electrodes 740 to 760, and the base unit 730 includes material that is deformable in response to an electric signal and has an initial concave shape.

Referring to FIG. 7A, a positive (+) voltage or charge is applied to the first electrode 740, and a positive (+) voltage or charge is applied to the second electrode 750 so that repulsive force is generated between the first electrode 740 and the second electrode 750. In this regard, the repulsive force is affected by the initial shape of the base unit 730. If the base unit 730 has a less concave shape, the axially central portion of the curved surface of the lens unit 720 may excessively protrude upward.

Referring to FIG. 7B, the third electrode 760 is grounded so that electrostatic force is generated between the second electrode 750 and the third electrode 760. In this case, the shape of the base unit 730 is changed by the electrostatic force. For example, a region of the base unit 730 that corresponds to the drive region of the lens unit 720 is compressed and thus lowered in height. That is, the base unit 730 has a more concave shape. Therefore, the shape in which the axially central portion of the curved surface of the lens unit 720 excessively protrudes upward may be compensated for. Consequently, generated aberration can be partially or fully compensated for.

Although, in FIGS. 1 to 7B, there are illustrated only examples in which the upper surface of the base unit 230 to 730 is convex or concave in a hemispherical shape, the present disclosure is not limited to this. For example, the upper surface of the base unit 230 to 730 may include a plurality of convex protrusions, or a plurality of concave protrusions. Furthermore, the base unit 230 to 730 may be formed in various convex/concave shapes, for example, a hexahedral shape, a tetrahedral shape, etc.

FIG. 8 is a view illustrating an example of an optical system including an active reflective lens according to an embodiment of the present disclosure.

Referring to FIG. 8, an optical system (or an imaging system) according to an embodiment of the present disclosure may include an active reflective lens 810 according to any one of the foregoing embodiments, an image sensor 820, and so forth. In the case where light is incident at an angle of 45 degrees or obliquely on the active reflective lens 810 according to an embodiment of the present disclosure, the light may be reflected by the active reflective lens 810 and be incident on the image sensor 820.

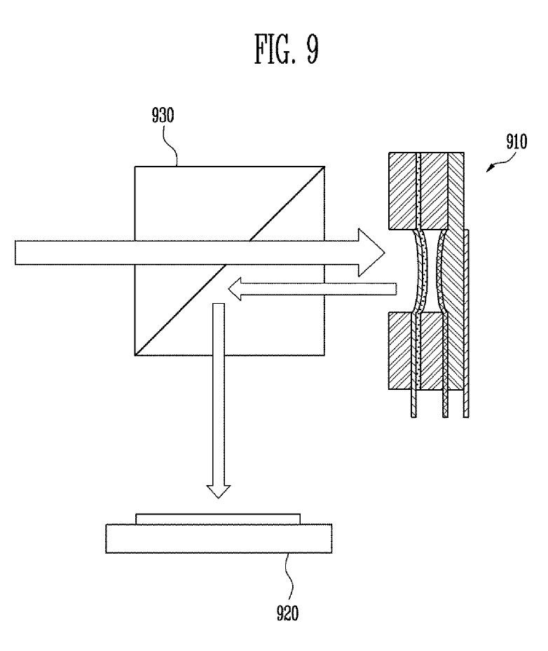

FIG. 9 is a view illustrating another example of an optical system including an active reflective lens according to an embodiment of the present disclosure.

Referring to FIG. 9, an optical system (or an imaging system) according to an embodiment of the present disclosure may include an active reflective lens 910 according to any one of the foregoing embodiments, an image sensor 920, a beam splitter 930, and so forth. In this case, light may be perpendicularly incident on the active reflective lens 910. The beam splitter 930 may function to allow some of light to transmit therethrough while reflecting the other portion of the light. For example, a ratio of reflection to transmission in the beam splitter 930 may be changed in various values, for example, 50:50, 30:70, etc., depending on the purpose of use of the system. The illustrated structure may facilitate the configuration of the system and reduce aberration because light is perpendicularly incident on the active reflective lens 910.

An imaging system that is used in practice may include, depending on the purpose of use, additional optical elements between the elements, that is, the varifocal lens (i.e., the active reflective lens) 810, 910, the image sensor 820, 920, and the beam splitter 930 that have the structures illustrated in FIG. 8 or/and FIG. 9.

Furthermore, an active reflective lens according to an embodiment of the present disclosure may be used in various optical apparatuses such as a camera, a portable terminal, a projector, a TV, and the like.

The embodiments disclosed in the present specification and the drawings just aims to help those with ordinary knowledge in this art more clearly understand the present disclosure rather than aiming to limit the bounds of the present disclosure. Therefore, one of ordinary skill in the art to which the present disclosure belongs will be able to easily understand that various modifications are possible based on the technical scope of the present disclosure.

Meanwhile, exemplary embodiments of the present invention have been described with reference to the accompanying drawings, and specific terms or words used in the description should be construed in accordance with the spirit of the present invention without limiting the subject matter thereof. It should be understood that many variations and modifications of the basic inventive concept described herein will still fall within the spirit and scope of the present disclosure as defined in the appended claims and their equivalents.

What is claimed is:

1. An active reflective lens comprising:
a lens unit including material that is deformable in response to an electric signal;
a support unit configured to support the lens unit;
a base unit formed below the support unit;
a first electrode formed on the lens unit; and
a second electrode formed on the base unit,
wherein a distance between the first electrode and the second electrode is determined depending on a shape of an upper surface of the base unit, and the distance between the first electrode and the second electrode varies depending on regions of the lens unit.

2. The active reflective lens according to claim 1, wherein the lens unit is deformed by electrostatic force between the first electrode and the second electrode, and the electrostatic force applied to the lens unit varies depending on the regions of the lens unit.

3. The active reflective lens according to claim 1, further comprising:
a third electrode formed on a lower surface of the base unit,
wherein the second electrode is formed on the upper surface of the base unit, and a distance between the second electrode and the third electrode is determined depending on a thickness of the base unit that depends on a position on the base unit.

4. The active reflective lens according to claim 3, wherein the base unit includes material that is deformable in response to an electric signal, and is deformed by electrostatic force between the second electrode and the third electrode.

5. The active reflective lens according to claim 4, wherein a shape into which the base unit is deformed changes depending on a dielectric constant or properties of the deformable material.

6. The active reflective lens according to claim 4, wherein a curvature of the second electrode varies depending on deformation of the base unit, and a curvature of the first electrode varies depending on the curvature of the second electrode.

7. The active reflective lens according to claim 6, wherein the first electrode is formed of metal that is reflectible even after the lens unit is deformed.

8. The active reflective lens according to claim 6, wherein each of the second electrode and the third electrode includes flexible material.

9. The active reflective lens according to claim 1, wherein at an initial state in which no voltage is applied to the first and second electrodes, the upper surface of the base unit is curved.

10. The active reflective lens according to claim 1, wherein the lens unit includes a drive region and a non-drive region, and the support unit includes an opening through which the drive region is exposed, and fixes the non-drive region in place.

11. The active reflective lens according to claim 1, wherein when an attractive force is generated between the first electrode and the second electrode, the lens unit is deformed into a concave lens.

12. The active reflective lens according to claim 1, wherein when a repulsive force is generated between the first electrode and the second electrode, the lens unit is deformed into a convex lens.

13. The active reflective lens according to claim 1, further comprising:
a power supply configured to apply a voltage to the first electrode and the second electrode.

14. An optical apparatus including an active reflective lens, the active reflective lens comprising:
a lens unit including material that is deformable in response to an electric signal;
a support unit configured to support the lens unit;
a base unit formed below the support unit;
a first electrode formed on the lens unit; and
a second electrode formed on the base unit,
wherein a distance between the first electrode and the second electrode is determined depending on a shape of an upper surface of the base unit, and the distance between the first electrode and the second electrode varies depending on regions of the lens unit.
